(19) United States
(12) Patent Application Publication
(10) Pub. No.: US 2025/0297197 A1
(43) Pub. Date: Sep. 25, 2025

(54) HIGH POROSITY WATER-SOLUBLE SHEET DETERGENT CONTAINING THERMOLABILE OR VOLATILE ACTIVE SUBSTANCES, AND PROCESS FOR MANUFACTURING THE SAME

(71) Applicant: ZOBELE HOLDING S.P.A., TRENTO (IT)

(72) Inventors: Giampaolo FERRONATO, Villa del Conte (Padova) (IT); Victoria CHEPTENE, Trento (IT); Alessandro CAGNINA, Ponte San Nicolò (Padova) (IT); Stacey HOUSE, Metuchen, NJ (US); David CLIFFORD, Greenwood Lake, NY (US); Mike KAVANAGH, Wood-Ridge, NJ (US); Aldona GRZYBOWSKI, New York, NY (US); Keith LAURSEN, Wallingford, CT (US)

(21) Appl. No.: 18/863,567

(22) PCT Filed: May 8, 2023
(86) PCT No.: PCT/IB2023/054752

§ 371 Date: Nov. 6, 2024

(30) Foreign Application Priority Data
May 9, 2022 (IT) 102022000009470
May 4, 2023 (IT) 102023000008826

(51) Int. Cl. C11D 17/04; C11D 17/06

(52) U.S. Cl. CPC C11D 17/044; C11D 17/06; C11D 2111/12; C11D 2111/40

(57) ABSTRACT

Process for manufacturing a solid water-soluble sheet detergent containing sensitive additives, which includes the steps of: manufacturing two continuous films of sheet detergent free of sensitive additives, by means of a solution casting process starting from a homogeneous and finely aerated mixture, and then superimposing and coupling under lamination said films, simultaneously including said sensitive additives therebetween, as an aqueous solution or dispersion, to obtain a single multilayer film. The invention also relates to sandwiched water-soluble sheet detergent s, wherein said sheet s are made of a non-fibrous detergent composition, have a microporous internal structure, and are free of sensitive additives, a thin layer of sensitive additives being included at the interface between said water-soluble sheets.

### FIELD OF THE INVENTION

The present invention relates to a high porosity water-soluble sheet detergent, and specifically to a sheet detergent of this type also including thermolabile or volatile active substances.

The invention further relates to a preferred process for manufacturing said high porosity water-soluble sheet detergent containing thermolabile or volatile active substances.

### PRIOR STATE OF THE ART

In the field of detergents, in particular in the field of laundry detergents, products are known since long which are formulated as solid water-soluble sheets, instead than traditional powders or liquids. Sheet formulation, in fact, makes it possible to achieve easy handling and dosing precision, to avoid any risk of accidental leak or dispersion even as inhalable powders dispersed in the air, and, finally, to minimize the specific volume of the detergent, thus also enabling a reduction of packaging and freight costs.

Most recent sheet detergents are entirely water-soluble, i.e., free from any insoluble support, and are produced from a suitable aqueous solution of a detergent composition through a controlled casting process-known as “solution casting” process—on a heated moving support, such as for example a rotating cylinder or a conveyor belt. The manufacturing process basically includes the following steps:
1. dissolving the basic detergent composition in an aqueous solution containing suitable film-forming components;
2. dosing the aqueous solution obtained in step 1 in laminar form on a moving support (cylinder or conveyor belt), using weir, guillotine or calender systems depending on the solution viscosity, to form a continuous film with constant desired thickness on the moving support;
3. drying the film by applying heat (infrared, forced ventilation, hot water heating, etc.) to the moving support until solidification of the film;
4. detaching the thus obtained solid film from the moving support (by means of a doctor blade device or the like);
5. cutting the continuous solid film into the desired sizes;
6. packaging the thus obtained water-soluble sheet detergent.

U.S. Pat. No. 9,464,264 (2016) discloses a process and relative apparatus for manufacturing a sheet detergent of the type illustrated above.

US-2019/010431 (2019) discloses a water-soluble sheet detergent, wherein sheets of two different types are provided, each type of sheet containing substances useful to a different type of washing process—for example, in particular, detergents and softeners—and being characterized by different times of dissolution in the washing water. Said different types of sheets are then mutually coupled, so that, in use, direct contact in the washing water between the various useful substances contained in the coupled sheets is delayed.

US-2019/093057 (2019) discloses a water-soluble detergent sheet containing a first surfactant. A pair of identical sheets is coupled in a sandwich, and discrete solid particles of a second surfactant, which cannot be included in the sheets together with the first surfactant since it would make the sheets excessively sticky, are enclosed within said sandwich.

U.S. Pat. No. 11,193,097 (2021) discloses a water-soluble sheet detergent comprising a first water-soluble fibrous sheet superimposed on a second water-soluble fibrous sheet. A concentrated enzyme composition—consisting of one or more enzymes, water, and a water-binding agent—is included between the two fibrous, superimposed, and then mutually bonded sheets. This document represents the closest prior art of the present invention.

### TECHNICAL PROBLEM AND SOLUTION

The process for manufacturing sheet detergents disclosed by U.S. Pat. No. 9,464,264 entails a significant drawback when using thermolabile or volatile additives—and, more in general, all those additives of a detergent which undergo a degradation of their features, and/or vaporize when overheated or subjected to high mechanical stresses in the manufacturing process, hereinafter collectively referred to as sensitive components or additives—which are typically used in traditional liquid or powder detergents, such as for example enzymes and perfuming agents. As a matter of fact, since the process for manufacturing sheet detergents involves, as seen above, a mechanical processing step and a drying step at hot temperatures (120-170° C.), many of the sensitive additives commonly used in detergents would be subject to an irrecoverable deterioration, or a loss by vaporization, during the aforesaid processing steps of the manufacturing process. On the other hand, the mechanical processing step necessary to obtain a perfectly homogeneous mixture cannot be in any way mitigated nor the drying step can be carried out at too low temperatures as it would thus require very intense ventilation and an excessively long drying tunnel, making the entire process economically impractical. Furthermore, this type of solution would in any case entail the significant problem of treating the volatile substance vapours (e.g., perfuming agents) extracted in the drying step.

To overcome such drawbacks, which have so far significantly limited the field of application of sheet detergents, a post-addition of the sensitive additives on the detergent film coming from the drying step was already proposed in the prior art, so making said additives integral with the film by means of adhesive substances, or by permeation of the sensitive additives within the film thickness. However, such a solution entails the side drawback of leaving the sensitive additives exposed on the surface of the sheet detergent, then in direct contact with the user; this solution is therefore not acceptable, as regards the consumer protection, because the aforesaid sensitive additives often are or comprise allergenic products.

Further technical solutions for associating sensitive additives to a sheet detergent were disclosed by US-2019/093057 and U.S. Pat. No. 11,193,097. Both these solutions provide for the coupling of two sheets of a sheet detergent to form a sandwich, within which the sensitive additives are enclosed. However, in both cases the formation of special structures is provided which therefore complicate the detergent manufacturing process and increase the relative costs. In US-2019/093057 the sensitive additives need to be previously formed as solid granular components; while in U.S. Pat. No. 11,193,097 the sheet detergent must contain a water-soluble fibrous component. Both such solutions are aimed, in fact, at preventing an early weakening of the sheet detergent structure caused by the additives enclosed in the sandwich or, more precisely, by the aqueous component thereof.

The technical problem addressed by the present invention is therefore that of providing a water-soluble sandwich sheet detergent containing inside also sensitive additives, which requires neither fibrous structures for the sheet detergent formation nor containment solid structures of the sensitive additives, so that times and costs of the relative manufacturing process can be reduced.

As part of this technical problem, a first object of the invention is therefore to provide a sheet detergent, having a fine and homogeneous microporous structure, throughout the thickness of the sheets, to speed up and regularize the step of solvent evaporation and film formation and furthermore giving rise to a micro-reticular structure of the detergent solid sheets which endows them with greater rigidity and mechanical strength.

A second object of the invention is to provide a process for manufacturing sheet detergents, wherein the sensitive additives can be spread as aqueous solution or suspension into the sandwiches formed by coupled sheets of a sheet detergent, without causing any structural weakening of said sheets.

### BRIEF DESCRIPTION OF THE DRAWINGS

Further features and advantages of the sheet detergent according to the present invention will anyhow become more evident from the following detailed description of a preferred embodiment of the manufacturing process thereof, given by mere way of non-limiting example and illustrated in the accompanying drawings wherein:

FIG. 1 is a schematic view of a mixing and heating plant wherein the homogeneous liquid mixture for manufacturing a sheet detergent according to the present invention is prepared;

FIG. 2 is a schematic view of an alternative embodiment of the mixing and heating plant of FIG. 1;

FIG. 3 is a schematic view of a plant for aerating the homogeneous liquid mixture exiting the mixing and heating plant of FIGS. 1 and 2;

FIG. 4 is a schematic view of a plant for solution casting of the aerated homogeneous mixture exiting the aeration plant of FIG. 3, for manufacturing a continuous sheet of a sheet detergent;

FIG. 5 is a schematic view of a plant for coupling two continuous sheets of a sheet detergent exiting the solution casting plant of FIG. 4, with the interposition of sensitive additives, to form a sheet detergent according to the present invention;

FIG. 6 is a graph illustrating the results of a comparative washing trial, among a sheet detergent according to the invention and some known comparable products, on standard stains No. C-10 Pigment, Oil, Milk (POM) prepared according to the “AISE stainset” standard (AISE—International Association for Soaps, Detergents and Maintenance Products), applied on a white cotton fabric;

FIG. 7 is a graph like that of FIG. 6 on standard stains No. C-S-38 Egg yolk with carbon black, aged;

FIG. 8 is a graph like that of FIG. 6 on standard stains No. C-S-28 Rice starch, coloured;

FIG. 9 is a graph like that of FIG. 6 on standard stains No. C-S-103 Wine;

FIG. 10 is a graph like that of FIG. 6 on standard stains No. C-02 Olive oil with carbon black;

FIG. 11 is a graph like that of FIG. 6 on standard stains No. C-S-01 Blood, aged;

FIG. 12 is a graph like that of FIG. 6 on standard stains No. C-S-26 Corn starch, coloured;

FIG. 13 is a graph like that of FIG. 6 on standard stains No. C-S-12 Blackcurrant juice, aged;

FIG. 14 is a graph like that of FIG. 6 on standard stains No. C-S-132 High discriminative sebum BEY, pigment;

FIG. 15 is a graph like that of FIG. 6 on standard stains No. C-05 Blood, Milk, Ink (BMI);

FIG. 16 is a graph like that of FIG. 6 on standard stains No. C-S-06 Salad dressing with natural black;

FIG. 17 is a graph like that of FIG. 6 on standard stains No. C-S-17 Fluid make-up;

FIG. 18 is a graph like that of FIG. 6 on standard stains No. C-S-08 Grass, extract;

FIG. 19 is a graph like that of FIG. 6 on standard stains No. C-S-73 Locust bean gum with pigment;

FIG. 20 is a graph like that of FIG. 6 on standard stains No. C-S-216 Lipstick, diluted, red;

FIG. 21 is a graph like that of FIG. 6 on standard stains No. C-S-02 Cocoa, aged;

FIG. 22 is a graph like that of FIG. 6 on standard stains No. C-S-54 Oatmeal, coloured with chocolate, aged; and

FIG. 23 is a graph illustrating the CH 11 standard redeposition on a white cotton fabric (White Cotton Redeposition) during washing of the stained fabrics indicated in the previous Figures.

### DETAILED DESCRIPTION OF PREFERRED EMBODIMENTS

According to the present invention, to solve the problem highlighted above, a particularly simple and effective process for manufacturing sheet detergents was devised, wherein films of sheet detergent with no sensitive additives, having a fine and homogeneous microporous structure and smooth and compact outer surfaces are first produced. Then, at least two of said films are mutually coupled under lamination, after inserting said sensitive additives therebetween, in the form of an aqueous solution or dispersion, said additives being thus directly and perfectly incorporated into a final multilayer film of sheet detergent.

In the manufacturing process according to the invention, thus, the sensitive additives do not undergo any mechanical, heat or forced ventilation treatment, since both the step of applying the sensitive additives on a film of sheet detergent and the subsequent step of coupling under lamination two or more films of sheet detergent are carried out at room temperature and under low intensity mechanical stress. Furthermore, the sensitive additives remain perfectly enclosed between two films of water-soluble sheet detergent, thus avoiding any possibility of accidental contact with the user's hands.

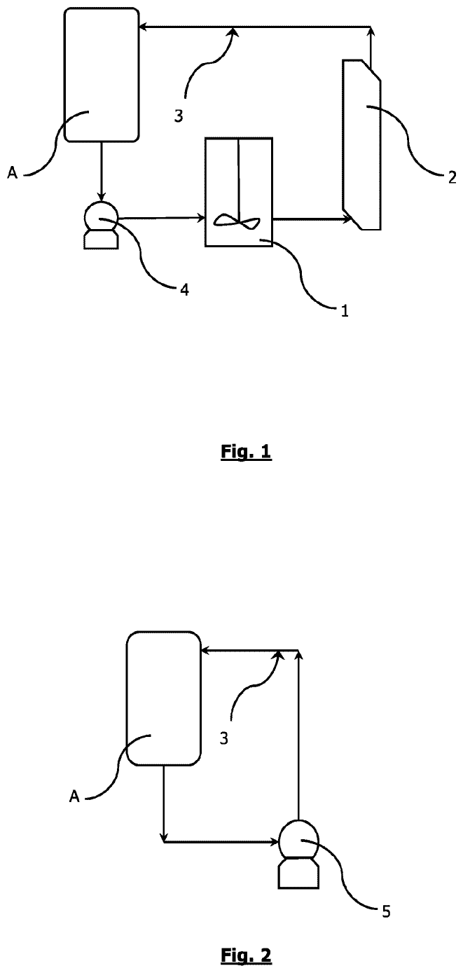

A preferred plant scheme for carrying out the above process is illustrated in the drawings, wherein the various components of the system are schematically illustrated in cross-section. FIG. 1 schematically illustrates the first step of the manufacturing process of a film of sheet detergent, by means of the solution casting process of the invention, consisting in mixing and heating the components of said sheet detergent.

The plant wherein this first step of the process of the invention is carried out comprises a tank A for loading the components, a mixer 1 wherein the sheet detergent components are thoroughly mixed, and a heat exchanger 2 which causes a progressive heating of the mixture until it reaches a temperature of about 80°-90° C. The tank A, the mixer 1 and the heat exchanger 2 are arranged in series along a recirculation circuit 3 wherein the mixture is circulated by a pump 4, until a perfectly homogeneous mixture of all the components is obtained in the tank A, heated to the desired temperature.

In the drawing, the heat exchanger 2 is represented as a separate device from the mixer 1, but the two functions of mixing and heating can also be carried out in a single device, for example a mixer equipped with an outer heating jacket. Furthermore, with reference to the system illustrated in FIG. 1, it should be noted that the use of a tank A separated from the mixer 1 and of the mixture recirculation circuit 3 is provided in the case of batch production wherein the single batch size exceeds the capacity of the mixer 1. Otherwise, for batch productions where the single batch size is equal to or smaller than the capacity of the mixer 1, the plant wherein the first step of the process is carried out simply consists of the mixer 1 equipped with its own heating means (not shown).

Due to the high viscosity of the thus obtained final mixture, the choice of mixer 1 is particularly delicate. In fact, although there are no special requirements for the mixing speed and the rotor shape of the mixer 1, the rotor shape must nevertheless guarantee effective homogenization of the mixture, avoiding the formation of dead zones and consequent possible buildups of unmixed or only partially mixed components on the walls and bottom of the mixer 1. On the other hand, the homogenization efficiency of the mixer 1 and the heat transfer efficiency of the heat exchanger 2 determine altogether the duration of the mixing and heating operation of a batch of components, and therefore also directly affect the costs of this first step of the process of the invention.

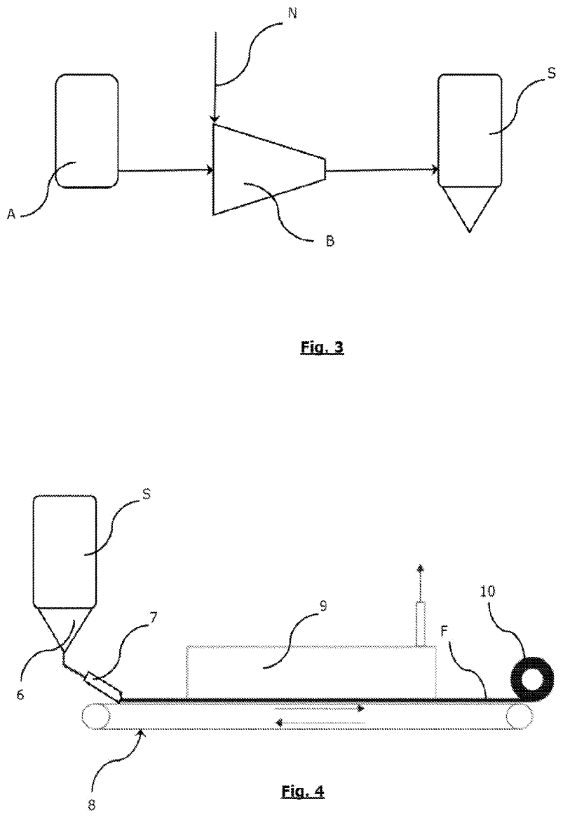

In this regard, from the trials conducted by the Applicant it was surprisingly found that particularly effective mixing and heating can be obtained by using a single pump 5 (FIG. 2) as long as the pump 5 is voluntarily made to work under constant cavitation conditions. The cavitation phenomenon (which instead must be normally avoided in pump management), in fact, makes it possible to transfer a large amount of mechanical and thermal energy to the viscous mixture very quickly, and therefore to reach the desired conditions of heating and complete homogenization of the mixture in much faster times than can be obtained with the combination of a traditional mixer 1 and a heat exchanger 2.

To obtain a perfectly homogeneous final mixture, the order in which the different types of components are added into the mixer 1 or the circuit 3 of the pump 5 is also relevant. Referring to a typical mixture for preparing a detergent sheet according to the present invention, as indicated in Table 1 below, water is added as the first component, which is then brought to the mixing temperature of 80°-90° C. The matting agent and then, gradually, the partially saponified polyvinyl alcohol in granules are subsequently added. Once complete dissolution of the polyvinyl alcohol is achieved, surfactants with a detergent effect are finally added and the mixture is further stirred until reaching a complete homogeneity of the same. The thus obtained mixture appears as a white non-fibrous paste, completely homogeneous, and, in particular, free from undissolved PVOH granules, having a viscosity in the range from 15,000 to 45,000 cP at 20° C. and from 8,000 to 24,000 cP at 30° C.

TABLE 1

| Typology | Chemical compound | % |
|---|---|---|
| PVOH | Partially saponified | 15-30% |
| | polyvinyl alcohol | |
| Surfactants with | MEA alkyl sulphate | 10-20% |
| detergent effect | C₁₂-C₁₄ + propylene | |
| | glycol | |
| | Ethoxylated C₁₂-C₁₄ | 5-10% |
| | alcohol (7 EO) | |
| | Topped coconut fatty | 2-5% |
| | acids | |
| | Monoethanolamine | 0.5-2% |
| | Sodium sulphite | 0.01-1% |
| Matting agent | Chemically treated | 0.5-2% |
| | silica | |
| Water | Demineralized water | 30-60% |

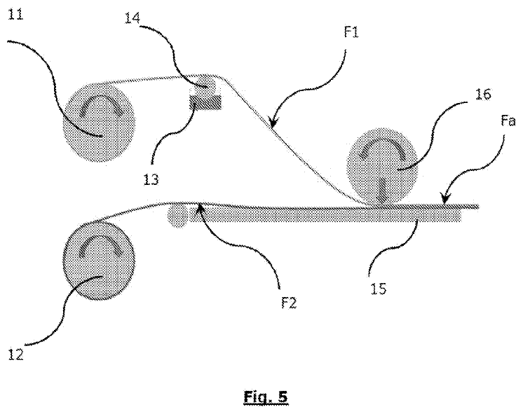

The second step of the manufacturing process of a sheet detergent of the invention, illustrated in FIG. 3, provides for fine aeration of the final homogeneous mixture exiting the tank A of the first mixing and heating step described above, by means of an aerator B equipped with an air inlet N, until a dense foam is obtained having a preferred density of approximately 0.60 g/cm³. According to a main feature of the present invention, in fact, it was found in the trials that a high degree of fine aeration of the homogeneous liquid mixture, ranging from liquid mixture to air ratios of 70/30 to 30/70, and preferably from 60/40 to 40/60, is an essential condition in order to obtain sheet detergents having a structure suitable for the final step of sandwich-coupling and insertion of said sensitive additives in the form of a liquid solution or suspension within the same sandwich. This second step of the process—i.e. fine aeration of the homogeneous mixture from the tank A or from a service tank wherein this mixture was temporarily stored—is preferably carried out with an aerator device specifically designed to form dense foams, for example the Compact-Mix apparatus “m11056” by HANSA-MIXER. The thus obtained aerated mixture is then sent to a tank S which feeds the controlled casting plant illustrated in FIG. 4.

Preparing the mixture of components as a dense foam formed by micro-bubbles of air homogeneously dispersed in the mass allows the water to evaporate from the mixture in a regular, fast, and effective way, during the film drying step, without giving rise to the formation of macro-bubbles of water vapor which causes the film being formed to break and therefore leaves strong surface irregularities on the finished surface of the sheet detergent. The film obtained according to the manufacturing process of the invention, from a homogeneous and highly aerated mixture, exhibits in fact a perfectly smooth outer surface and a regular and compact microporous inner structure caused by a fine and homogeneous porosity across the thickness of the film, with a pore diameter ranging from 25 to 500 nm and, preferably, from 50 to 400 nm. A film with such a structure provides a sufficient mechanical strength, in the step of forming the sandwich and inserting within the same the sensitive additives in a liquid phase, with no need to use fibrous structures to stiffen the film or containment structures of the sensitive additives, as provided instead by the prior art described above.

The homogeneous mixture still to be aerated has a satisfactory chemical-physical stability for a period in the order of a few months and can therefore be prepared in advance and stored until use. On the contrary, the aerated homogeneous mixture must be used as soon as possible in the third step of the process, i.e., in the step of forming sheets of the sheet detergent, to prevent the micro-bubbles of air dispersed in the homogeneous mixture from initiating a process of coalescence and migration. This process is all the slower the finer the dispersion of the micro-bubbles of air is, and therefore preparing an aerated mixture with finely dispersed air therein it entails the further advantage of a greater physical stability of the mixture during the subsequent step of the manufacturing process.

The third step of the process relates precisely to the formation of continuous sheets of sheet detergent and is already known per se. A typical plant for implementing this step is illustrated in FIG. 4 and comprises a tank S of the aerated mixture coming from the aerator B which feeds, through a hopper 6, a doctor blade 7 which spreads a film of aerated mixture on a steel conveyor belt 8. While travelling on the conveyor belt, the aerated mixture is partially dried in a dryer 9 until a continuous solid sheet F of sheet detergent is obtained, which is detached from the conveyor belt 8 and wound up in a roll 10. In the trial applications conducted by the Applicant, the doctor blade 7 is adjusted as to obtain a film of aerated mixture having a thickness of about 1.2 mm from which, after drying, a sheet F having a thickness of about 0.8-1.0 mm and a basis weight of about 160-180 g/m² is obtained.

The fourth step of the process of the invention is illustrated in FIG. 5 and provides for the use of two rollers 11 and 12 from which continuous films F1 and F2 of the desired sheet detergent, produced as indicated above, are respectively unwound. Downstream of the roller 11 a device for wet application of the sensitive additives dispersed or dissolved in an aqueous solution is provided, which device is suitable for wetting with said aqueous solution one or both the opposite surfaces of the two films F1 and F2. Wetting the surface of the films F1 and/or F2 with said aqueous solution can equally be carried out by means of a contact device (for example a roller, such as in the illustrated embodiment, or a doctor blade) or by means of a non-contact device (for example by spray or slot die coating) and in all cases results in the immediate chemical activation of the PVOH contained in said films, thus facilitating the subsequent bonding of the sensitive additives to the surface of the two films and the mutual bonding of the same with an excellent degree of adhesion.

FIG. 5, for example, schematically illustrates a wetting device for the film F1, comprising a tray 13 fed with said aqueous solution/suspension containing the sensitive additives, and a distribution roller 14 partially dipped therein. The side of the film F1 facing the film F2 is made to move in contact with the portion of said distribution roller 14 which is not dipped in the tray 13, to continuously wet the film F1 with a desired amount of the solution containing the sensitive additives. Such amount is preferably comprised between 50 and 200 g/m² and can be easily adjusted by modifying the surface roughness of the distribution roller 14, the viscosity of the solution contained in the tray 13, and possibly using a doctor blade device to adjust the thickness of the liquid collected by the distribution roller 14.

After the steps of wetting and applying the sensitive additives as indicated above, the films F1 and F2 are brought into mutual contact on a supporting surface 15 where they are then pressed onto each other by means of a lamination roller 16 or other, per se well known, equivalent device which allows to obtain a complete contact between the surface of the film F1 added with sensitive components and the untreated surface of the film F2, and thus the mutual bonding thereof due to the PVOH activation effect determined by the aqueous phase within which the sensitive components are added. Lamination must be carried out at a sufficient pressure to accomplish a permanent adhesion of the films F1 and F2, without this pressure causing local stresses such as to deteriorate the sensitive components enclosed between said films. It is thus obtained, at the same time, a complete segregation of a thin layer of sensitive additives within the thickness of the multilayer film Fa thus obtained. Said thin layer of sensitive additives is in fact included between the films F1 and F2, which form said multilayer film Fa, and thus remains completely inaccessible to the user in the normal use of the sheet detergent.

### Examples

### Examples of Formulation

The known formulations generally used in the solution casting process for manufacturing sheet detergents include, by way of example, the following components:
PVOH
Starches
Base with detergent properties
Dyes
Additives to achieve specific actions on the laundry (e.g., bleaches, softeners, anti-colour transfer agents, odour neutralisers)
Process adjuvants (e.g., absorbent silicas, release agents and the like)
Water (from 30% to 50%)

The addition of water is necessary to achieve a formulation viscosity suitable for being aerated and processed in the solution casting manufacturing process, achieving the required film thickness at the end of the drying step.

For the washing trials discussed below, a typical formulation has been prepared (although not exhaustive of the possible variants of the same) comprising the components reported in Table 1 and weight percentage falling within the ranges reported in the same Table 1.

### Washing Tests

White cotton fabric samples were stained with 17 different All-Purpose Monitor (CFT) staining products made by C.F.T. B.V. according to the AISE standard, to form identical series of 17 samples each. An 18th sample of white cotton fabric was further inserted to check for any redeposition of colours from the stained fabrics during the washing tests. Statistically significant groups of the series of fabric samples as described above were subsequently washed in a WKB 120 Miele washing machine at a temperature of 30° C. with a ‘Short’ (1 hour and 14 minutes length) cotton washing cycle using a different detergent for each group, namely:
a high-quality sheet detergent available on the market (benchmark);
a liquid detergent corresponding to the reference standard indicated by the current AISE regulation (IEC A* detergent);
an enzyme-free sheet detergent having a formulation in agreement with Table 1 (18×18 sample);
the above-mentioned sheet detergent added with enzymes according to the process of the present invention (Sample Type 1).

Once the washing tests were complete, the samples were dried, and the Stain Removal Index SRI was determined through standardized refractometric measurements on the stained and then washed samples and on washed unstained samples of the same fabric.

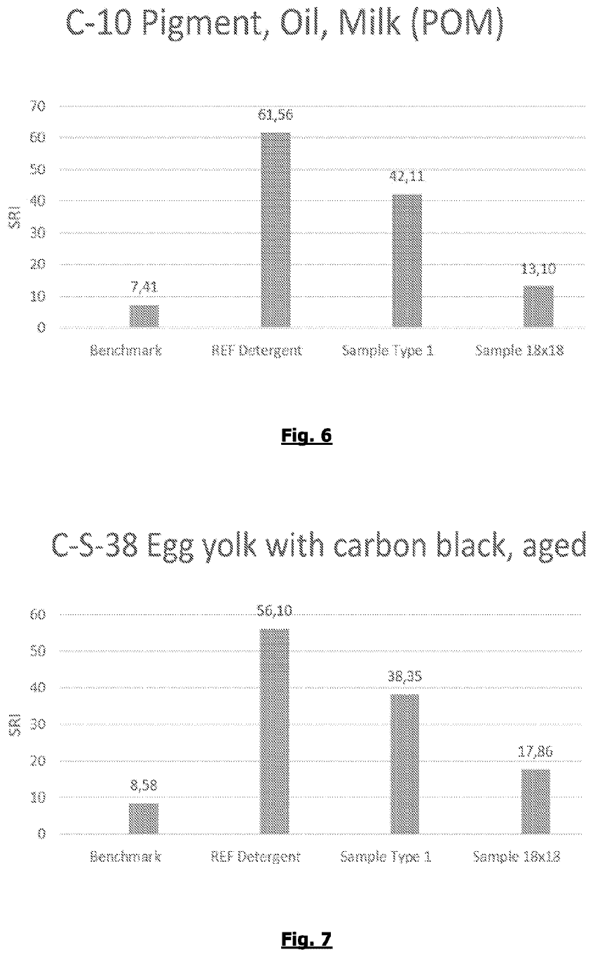

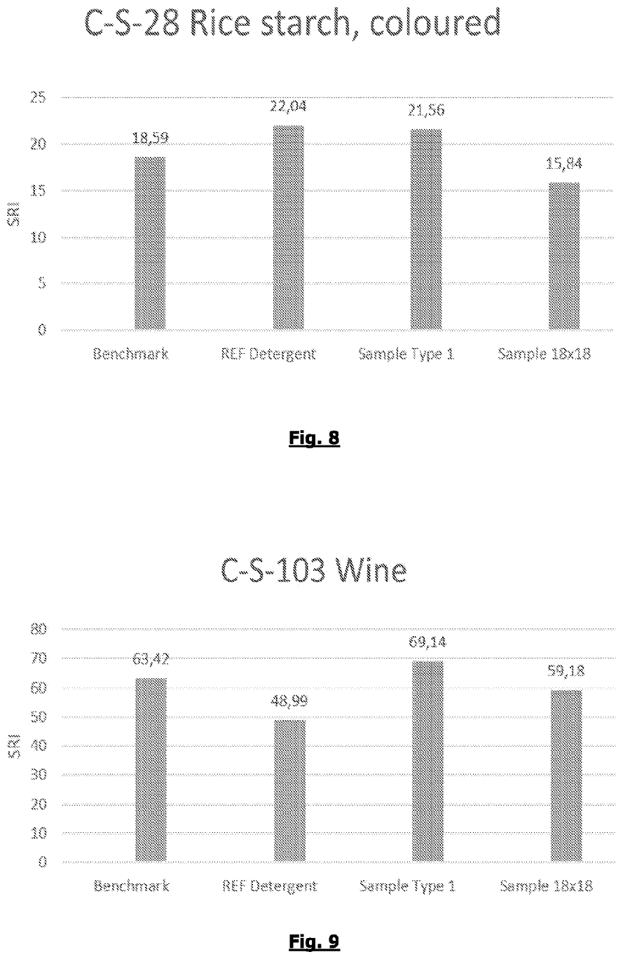

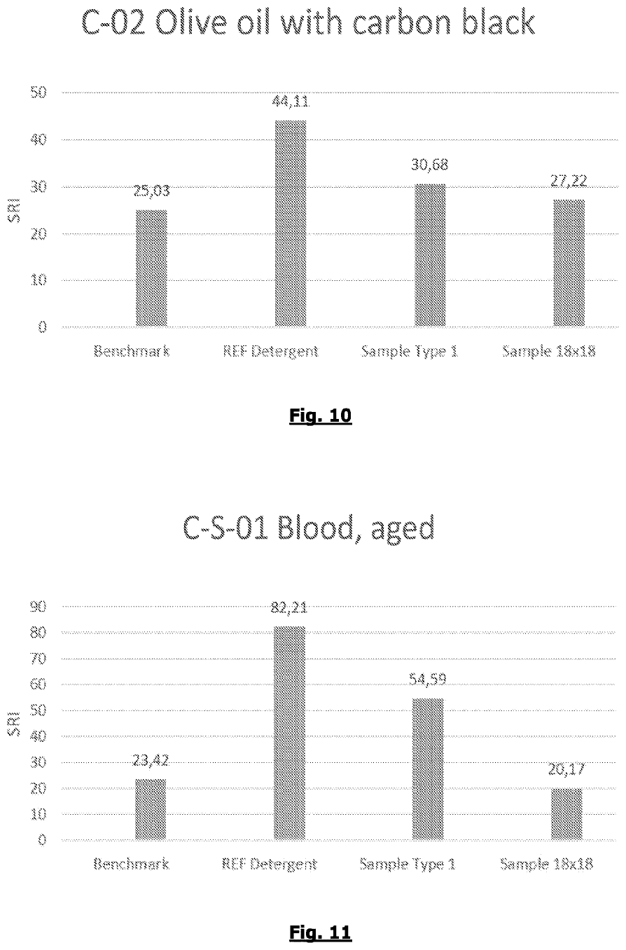

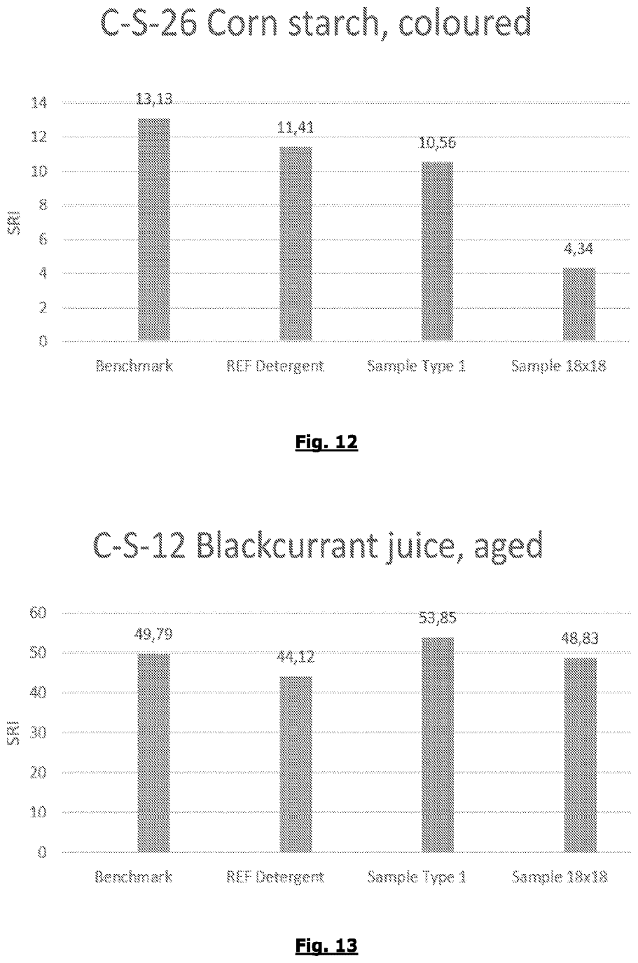

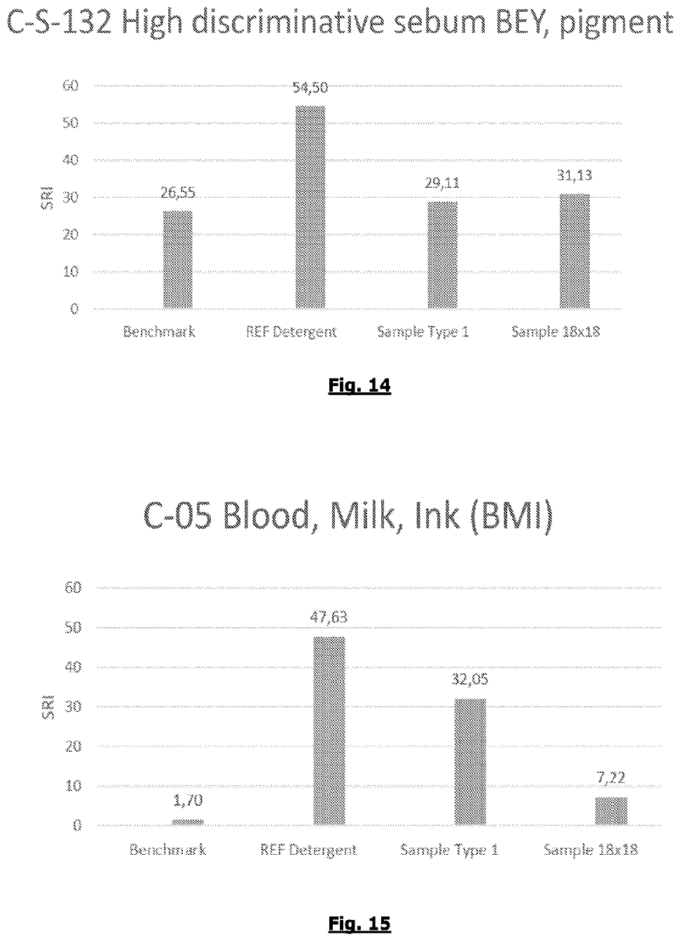

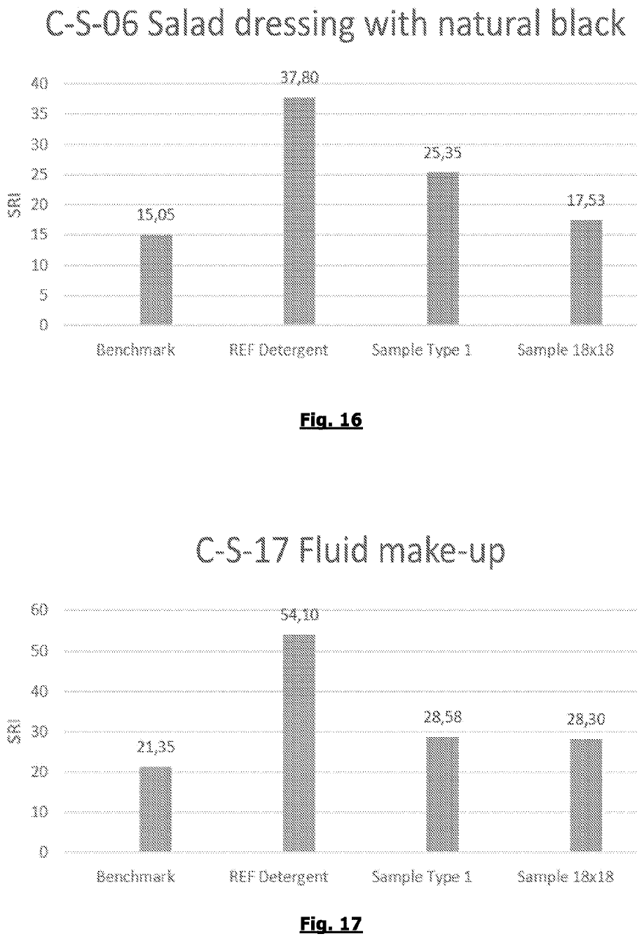

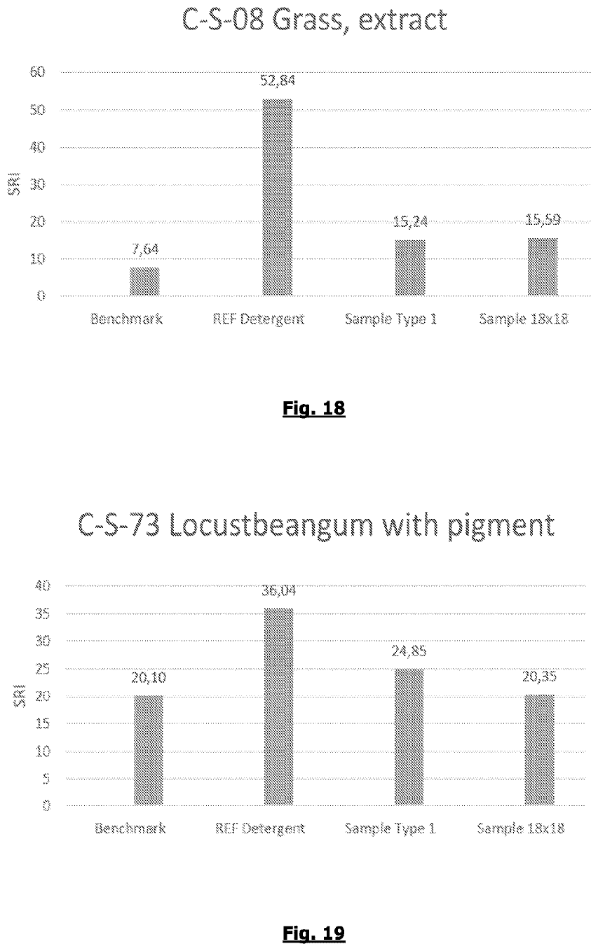

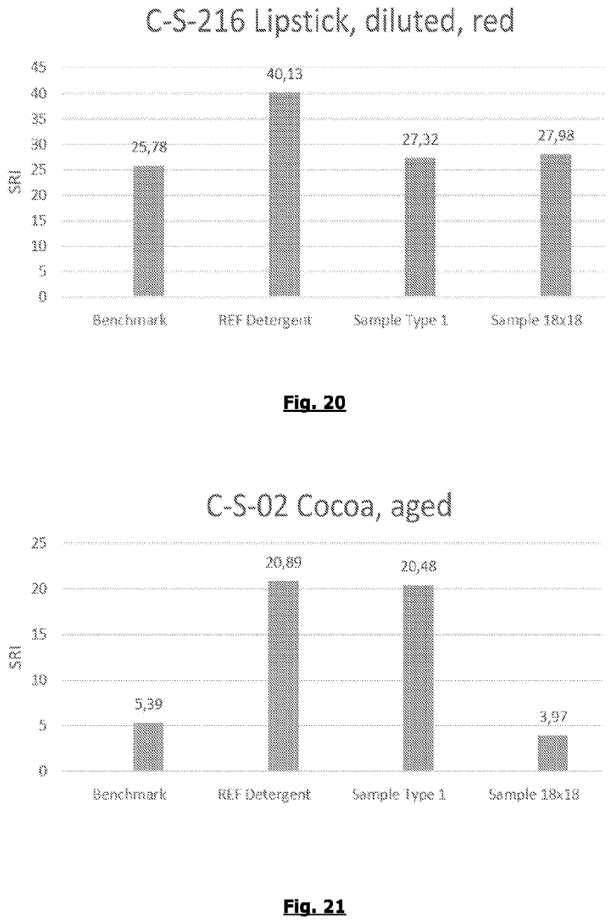

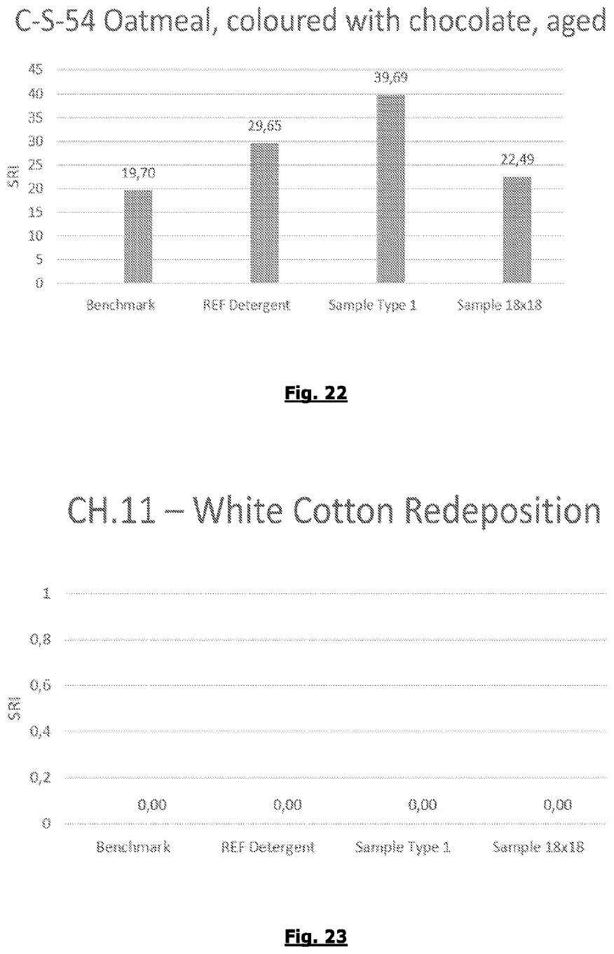

The results of the washing tests were averaged across the different results from the same group of 18-sample series, and the average results were reported in bar graphs in FIGS. 6-23, for the four groups corresponding to the four above said washing detergents. The SRI index is shown on the ordinate axis.

Examining the outcomes of said washing tests, one can notice that the samples according to the invention (Sample Type 1) exhibit better average washing performances compared to the samples washed with the external benchmark detergent (benchmark), and to those of the samples washed with the internal benchmark detergent (Sample 18×18), except for some types of stains, in the second case, where the performances are substantially similar. The sheet detergent according to the present invention was also noticed to be perfectly effective in avoiding any form of redeposition of coloured substances on the white cotton test samples (FIG. 19).

Therefore, it was shown that the addition of thermolabile additives, such as indeed enzymes, in a sandwich of water-soluble sheet detergents made it possible to achieve a significant improvement of the washing performance compared to the standard version of sheet detergent free of such additives, especially about some types of stains. These tests, therefore, show that the effectiveness of thermolabile additives in such special formulation of sheet detergent remains entirely unchanged; the sheet detergent according to the present invention and the process for manufacturing the same can therefore be applied to all other types of sensitive additives which can currently be used in sheet detergents only through the more complicated processes provided by the prior art, thus making the application of this solid formulation of detergents, which is particularly convenient and safe to use, more affordable.

From the foregoing description it is clear how the present invention has fully achieved all the intended objects, by making an initial perfectly homogeneous component mixture and then aerating the mixture with a high proportion of air until a dense and fine foam is obtained. In fact, both these operations make it possible to obtain a sheet detergent having a fine microporous reticular inner structure and a smooth outer surface, so that the sheet detergent can offer a sufficient mechanical strength when formed in a sandwich including sensitive additives in a liquid phase.

However, it is understood that the invention should not be considered as limited to the arrangements illustrated above, which are only exemplary embodiments thereof, but that different variants are possible all within the reach of a person skilled in the art, without thereby departing from the scope of protection of the invention itself, which is only defined by the following claims.

1. Process for manufacturing a solid water-soluble sheet detergent containing sensitive additives, comprising the steps
of:
a) manufacturing two or more continuous films of sheet detergent free of sensitive additives;
b) superimposing two or more of said continuous films of sheet detergent while including said sensitive additives therebetween; and
c) coupling said two or more continuous films of sheet detergent;
characterized in that
in said step a), said two or more continuous films of sheet detergent free of sensitive additives are manufactured by means of a solution casting process which includes the steps
of:
i) dissolving a non-fibrous basic detergent composition in an aqueous solution containing film-forming components, until a homogeneous mixture is obtained;
ii) aerating said homogeneous mixture to form micro-bubbles of air inside the same;
iii) dosing the aerated homogeneous mixture thus obtained in laminar form on a moving support to form on said moving support a film having a desired constant thickness;
iv) drying said film by applying heat and/or forced ventilation to the moving support;
v) detaching the obtained film of sheet detergent from the moving support;
in said step b) said sensitive additives are included between said two or more continuous films of sheet detergent as an aqueous solution or dispersion of the sensitive additives applied on at least one of the opposite surfaces of said two or more continuous films of sheet detergent;
and in said step c) said two or more continuous films of sheet detergent including therebetween said aqueous solution or dispersion of sensitive additives are laminated together into a single multilayer film.

2. Process for manufacturing a solid water-soluble sheet detergent as in claim 1, wherein the mutual bonding of said films of sheet detergent is due to a chemical activation effect of a PVOH contained in said two or more continuous films, determined by the aqueous phase within which said sensitive components are included.

3. Process for manufacturing a solid water-soluble sheet detergent as in claim 1, wherein said step a)-i) is carried out by heating said mixture to be homogenized at a temperature of 80-90° C. under mechanical stirring.

4. Process for manufacturing a solid water-soluble sheet detergent as in claim 3, wherein the heating and the mechanical stirring of the mixture to be homogenized are carried out by circulating the same by means of a pump maintained under constant cavitation conditions.

5. Process for manufacturing a solid water-soluble sheet detergent as in claim 1, wherein in said step a)-ii) the homogeneous mixture/air ratio is comprised in the range between 70/30 and 30/70, and preferably in the range between 60/40 and 40/60.

6. Process for manufacturing a solid water-soluble sheet detergent as in claim 1, wherein said steps b) and c) are carried out at room temperature.

7. Process for manufacturing a solid water-soluble sheet detergent as in claim 1, wherein the inclusion of the aqueous solution or dispersion of sensitive additives in said step b) is carried out by means of a contact device.

8. Process for manufacturing a solid water-soluble sheet detergent as in claim 1, wherein the inclusion of the aqueous solution or dispersion of sensitive additives in step b) is carried out by a non-contact device.

9. Process for manufacturing a solid water-soluble sheet detergent as in claim 7, wherein the applied amount of aqueous solution or dispersion of sensitive additives is comprised between 50 and 200 g/m2.

10. Process for manufacturing a solid water-soluble sheet detergent as in claim 1, wherein said lamination step c) is carried out between a roller and a supporting surface, or between two opposite rollers.

11. Process for manufacturing a solid water-soluble sheet detergent as in claim 1, wherein said continuous multilayer film is cut into desired pieces and packaged.

12. Solid water-soluble sheet detergent comprising two or more superimposed and sandwiched sheets of solid detergent, characterized in that said two or more water-soluble sheets are made of a non-fibrous detergent composition, have a microporous internal structure and are free of sensitive additives, and in that said detergent further comprises a thin layer of sensitive additives at an interface between adjacent pairs of said water-soluble sheets.

13. Solid water-soluble sheet detergent as in claim 12, wherein said internal microporous structure is homogeneous throughout the thickness of said sheets and has a pore diameter between 25 and 500 nm and, preferably, between 50 and 400 nm.

14. Solid water-soluble sheet detergent as in claim 13, wherein said sensitive additives comprise thermolabile and volatile substances.
